(19) United States
(12) Patent Application Publication
(10) Pub. No.: US 2026/0161630 A1
(43) Pub. Date: Jun. 11, 2026

(54) UPDATING USER-SPECIFIC CONDITIONING DATA USING MAPPINGS TO USER INTERACTIONS

(71) Applicant: GOOGLE LLC, Mountain View, CA (US)

(72) Inventors: Carsten Isert, Zurich (CH); Patrick Andreas Zoechbauer, Zurich (CH)

(21) Appl. No.: 18/972,181

(22) Filed: Dec. 6, 2024

(51) Int. Cl. G06F 16/23; G06F 16/2458

(52) U.S. Cl. CPC G06F 16/2365; G06F 16/2458

(57) ABSTRACT

Implementations described herein relate to updating user-specific conditioning data (USCD) using mappings to user interactions. In various implementations, Data indicative of new user interactions between a user and computing device(s) may be stored. Based on the new user interactions, portions of USCD representing user attributes may be updated. The USCD may be operable to condition a generative model to generate model output tailored to the user. Mappings between the updated portions of the USCD and the data indicative of the new user interactions may also be stored. When it is determined that user interaction(s) have been altered, the mappings may be used to update corresponding portions of the USCD to reflect the alteration of the user interactions.

### BACKGROUND

Generative models such as single-modal or multi-modal large language models (LLMs) (e.g., vision language models or “VLMs”) can be used to process sequences of input tokens to generate sequences of output tokens. Generative models are applicable across a wide range of tasks. For example, generative models are increasingly being used to power automated assistants (also referred to as “virtual assistants” or “chatbots”), which enable humans (which are referred to as “users” when interacting with automated assistants) to participate in natural language dialogs with automated assistants. Some generative models that are pretrained/trained using web-scale data are referred to as “foundation” models. Recent iterations of generative models are able to process increasingly large amounts of data at once. Put another way, recent generative models have increasingly growing “context windows.”

### SUMMARY

When users engage with automated assistants, they may expect the automated assistants to “learn” from interactions with the user so that the automated assistants become increasingly personalized (or “bespoke”). For example, a vegetarian user may expect his or her automated assistant to learn—from an explicit input by the user and/or from observing various interaction(s) between the user and computing device(s) over time—that the user does not wish to receive restaurant recommendations for establishments with few or no vegetarian options.

As another example, users often use automated assistants to control smart appliances such as lights, thermostats, locks, media playback devices, etc. Those users may expect that as they make changes to their smart appliances—whether it be commissioning new appliances, altering existing appliances, or decommissioning existing appliances—the automated assistant will be made aware of those changes and respond to future requests appropriately. For example, if a user adds a smart light to a kitchen, the user may expect that future invocations of “turn on all the kitchen lights” will cause the new smart light to be turned on, too.

Some automated assistants may be personalized by building and maintaining a personalized user data structure, e.g., in the form of one or more database tables, a personalized knowledge graph, etc. Such a personalized user data structure may be updated manually by the user and/or automatically, e.g., when the user alters a smart appliance configuration, accepts or rejects a recommendation (e.g., of digital content, restaurant, etc.), engages in patterns of behavior (e.g., repeatedly eating the same type of cuisine), etc. However, conventional automated assistants may access personalized user data structures programmatically and/or using predefined actions, which can become unwieldy as the personalized data structure grows with increasingly heterogeneous data (e.g., emails, text messages, various user interactions with computing devices, etc.).

Implementations described herein relate to building and maintaining “user-specific conditioning data” (USCD) in association with individual users, as well as using USCD in conjunction with generative artificial intelligence (AI) to generate content that is tailored to individual users. The USCD may be built and/or maintained by accumulating data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), individuals submitting search queries and/or consuming content responsive to search queries, individuals'browsing data, individual engagement with social media, individual engagement with generative models (including any modality of data provided by the individual to the generative model, or generated using the generative model), individuals' consumption of documents and/or media (e.g., images, videos, games, podcasts, music, etc.), individuals' engagement with mapping applications (including accumulated locations, saves places, etc.), device and/or application configuration (e.g., applications installed on a mobile device, integration between applications, mobile device settings, etc.), data derived from documents created and/or edited using productivity software (e.g., word processing documents, spreadsheets, presentations), task lists, shopping lists, chats (e.g., SMS, MMS), reviews the individuals have posted (e.g., about restaurants, recipes, products), photos (including captions and/or detailed summaries of photos generated using generative models such as VLMs), payments made and/or received by individuals (including comments or metadata provided with those payments), third party software, personal uniform resource locators (URLs), and so forth.

While many examples described herein related to users interacting with generative model-powered automated assistants, this is not meant to be limiting. Techniques described herein are applicable outside of the automated assistant context. For example, techniques described herein may enable users of AI-powered productivity software, such as word processors, spreadsheets, presentation programs, etc., to have increasingly bespoke experiences. As another example, users engaging with a general-purpose generative model interaction interface (e.g., not specifically an automated assistant) such as might be provided via a web browser may benefit from techniques described herein.

As yet another example, an integrated development environment (IDE) or other application in which source code can be created/edited may include a generative AI assistant configured with selected aspects of the present disclosure. As yet another example, a robot that can be controlled using natural language may benefit from techniques described herein. Conditioning the robot's behavior on the individual's attributes and/or context represented by the individual's USCD may cause the robot to behave in a manner that is not only responsive to the individual's explicit command, but also is aware of the individual's personal preferences, context, attributes, etc. For example, if the individual asks the robot, “can you get me something to drink,” an underlying world model (implemented as a generative model) of the robot may be able to ascertain the individual's personal preferences and bring back a beverage that the individual is more likely to enjoy.

Techniques described herein may give rise to various technical advantages. For example, techniques described herein may leverage new user interactions between a user and a client device to update a user's USCD, such as by adding new user attributes that, if accounted for when the individual engages with generative AI, would benefit the user's experience by making responses more useful and/or tailored to a user's specific situation. This in turn may decrease the interaction required, thereby reducing the use of computational resources such as memory and processor cycles.

Techniques described herein may also enable generative model input prompts (or context) to be shortened because the raw data that is used to formulate USCD may be compressed in various ways, such that the resulting USCD is more concise than the underlying raw data, or than what a user may provide as a manual prompt. For example, natural language describing aspects or attributes of a user, such as electronic correspondence, consumed documents, database tables, etc., may be condensed using techniques such as generative model-based textual summarization prior to being assembled into the USCD. Additionally or alternatively, the USCD could be formulated as reduced-dimensionality, semantically-rich embedding(s) that can be represented using far fewer input tokens than, for instance, natural language, database tables, logs of user queries, emails or other electronic correspondence in native formats, etc. Having concise USCD may decrease—potentially to a significant degree—the amount of calculations required to process the input prompts, thereby decreasing computational cost/load and/or latency experienced by the user.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example of how various components of FIG. 1 may cooperate to conduct selected aspects of the present disclosure.

FIG. 3 schematically depicts an example of how user interactions from a variety of different sources may be accessible to components such as a user profile engine and a user-specific conditioning data (USCD) engine to update USCD based on changes to user interactions made by individuals.

FIG. 4 schematically depicts an example of USCD and mappings between portions of the USCD and various sources data indicative of corresponding user interactions.

FIG. 5 is a flowchart illustrating an example method of performing selected aspects of the present disclosure.

FIG. 6 schematically depicts an example architecture of a computer system.

### DETAILED DESCRIPTION

Implementations described herein relate to building and maintaining “user-specific conditioning data” in association with individual users, as well as using user-specific conditioning data in conjunction with generative artificial intelligence (AI) to generate content that is tailored to individual users. User-specific conditioning data (often abbreviated herein to “USCD”) may be built and/or maintained by accumulating and/or monitoring data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), users submitting search queries and/or consuming content responsive to search queries, user engagement with social media, users creating and/or consuming documents, and so forth. USCD itself may be expressed in various forms, such as a textual description/summary of the individual's attributes, tokens/embeddings encoding the individual's attributes, images and/or other modalities that convey the individual's attributes, or any combination thereof.

Individuals may exert various levels of control over the data that is indicative of their interactions with computing devices. These changes should also be reflected in the individuals'USCD. As a working example, an individual planning a surprise party for a roommate may operate a web browser to issue search queries relating to throwing surprises parties and consume various responsive documents. The individual may wish to conceal these actions, including the individual's search history and browsing history, from the roommate for which the surprise party is being thrown. Concealing these actions in the individual's web browser may be simple enough—they can simply delete their search and browsing histories, or even operate in “incognito mode” at the outset.

However, if these search and/or browsing histories are captured as user interactions and incorporated into the individual's USCD prior to the individual deleting them, then subsequent generative model queries issued at computing device(s) controlled by or otherwise associated with the individual may nonetheless reflect these user interactions. Suppose the individual and the roommate share a “smart” speaker in a common area of their apartment. The smart speaker may facilitate interaction with a generative AI-powered automated assistant, and may be associated with a user profile of the individual. If the roommate issues a generative model query to the smart speaker, the generative model response provided by the automated assistant may be conditioned on the individual's USCD, and therefore may be tailored to the individual. This presents a risk that clues about the individual's plans to throw the roommate a surprise party could be surfaced to the roommate.

Accordingly, implementations are described herein for detecting changes made by individuals to data indicative of user interactions between the individuals and computing devices, and updating the individuals'USCD to reflect these changes. More particularly, but not exclusively, techniques are described herein for storing mappings between user interactions and corresponding portions of USCD, and using those mappings subsequently to propagate changes (e.g., modifications, deletions) made to data indicative of user interactions to corresponding portions of USCD, so that the USCD reflects those changes. Put another way, the mappings may be used as a “reverse lookup” to identify which portion(s) of USCD correspond to the altered user interactions, so that those identified portion(s) of the USCD can be updated accordingly. When the USCD is used subsequently to condition generative model output, e.g., provided by a generative AI-powered automated assistant or otherwise, that generative model output will be reflective of those changes to the underlying user interactions.

User interactions may take numerous forms, and may, when incorporated into USCD, condition generative model(s) in various ways. In some implementations, the data indicative of new user interaction(s) may include electronic correspondence (e.g., emails texts, direct messages) sent or received by the individual. For example, the individual may receive an email or notification indicating that an upcoming flight has been canceled. The individual's USCD may be updated to reflect that flight's cancelation (whereas prior to this update, the individual's USCD may have assumed the flight was still departing as scheduled). Consequently, when the individual issues a new generative model query relating to his or her upcoming schedule, that flight's cancelation will be reflected in the generative model's output.

Additionally or alternatively, the new user interaction(s) may include search engine queries formulated and/or submitted by or on behalf of the individual. For example, the individual may issue one or more search engine queries seeking recommendations for vegetarian restaurants suitable for “work gatherings.” Techniques described herein may update the individual's USCD to reflect the user's preference for vegetarian cuisine in relation to “work gatherings.” Mapping(s) between data indicative of the individual's search engine quer(ies) and the corresponding portions of the individual's USCD may be stored as well. If for some reason the individual's preference for vegetarian cuisine in relation to work gatherings changes, e.g., because vegetarian coworker(s) will no longer be attending, the individual can modify that preference, e.g., by manually deleting search and/or browsing history entries associated with that preference. These manual deletions may be detected, and the aforementioned mappings may be used to identify corresponding portion(s) of the individual's USCD. These corresponding portion(s) of the individual's USCD may then be deleted.

In some implementations, user interaction(s) may include document(s) consumed by the user. For example, the user may read a technical manual explaining how a particular smart appliance is operated. Techniques described herein may update the individual's user-specific conditioning data to the individual's consumption of that technical manual. Consequently, when the individual issues a new generative model query relating to operating that smart appliance, content of that technical manual may be accounted for by the generative model, e.g., to condition the generative model output towards new information not contained in that technical manual.

In some implementations, user interaction(s) may include interactions that relate to commissioning a new smart appliance into a coordinated ecosystem of smart appliances associated with the user, altering a configuration of a smart appliance within the coordinated ecosystem, and/or decommissioning a smart appliance from the coordinated ecosystem. For example, an individual's household may initially include some number of smart appliances (e.g., lights, thermostats, blinds, locks, televisions, etc.), and these appliances'“configuration data” (e.g., any data usable to identify, access, interact with, and/or operate a smart appliance) may be incorporated into the individual's user-specific conditioning data, automatically and/or manually by the individual.

Suppose the individual replaces a smart light bulb with a “regular” (e.g., non-networked) light bulb. The individual may operate a home automation client application to delete the smart light from smart home configuration data accessible by their home automation client. With the individual's express approval, this deletion may be detected, e.g., by a user interactions engine running on one or more client devices controlled by the individual and/or by a cloud-based user interactions engine. In response to the deletion, a mapping from the deleted portion of the individual's smart home configuration data to corresponding portion(s) of the individual's USCD may be followed and used to delete the corresponding portion(s) of the individual's USCD. Consequently, when the individual subsequently issues a generative model query that, for instance, seeks information about statuses of the individual's smart appliances, the generative model response will either omit any mention of the smart light bulb that was removed, or in some cases may remind the individual of the smart light bulb's removal.

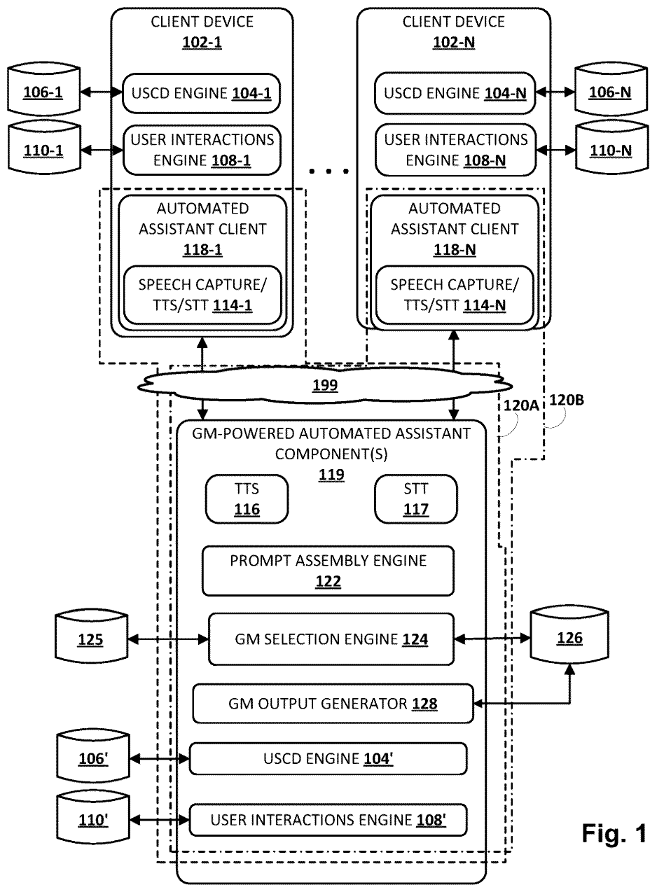

Now turning to FIG. 1, an example environment in which techniques disclosed herein may be implemented is illustrated. The example environment includes a plurality of client computing devices 102-1 to 102-N. Each client device 102 may execute a respective instance of an automated assistant client 118. One or more GM-powered automated assistant components 119 may be implemented on one or more computing systems/servers (collectively referred to as a “cloud” computing system) that are communicatively coupled to client devices 102-1 to 102-N via one or more local and/or wide area networks (e.g., the Internet) indicated generally at 199. Moreover, one or more GM-powered automated assistant components 119 might alternatively be implemented at one or more of client devices 102.

An instance of an automated assistant client 118, by way of its interactions with one or more GM-powered automated assistant components 119, may form what appears to be, from the user's perspective, a logical instance of an automated assistant 120 with which the user may engage in a human-to-computer dialog. Two instances of such an automated assistant 120A, 120B are depicted in FIG. 1 in dashed line. It thus should be understood that each user that engages with an automated assistant client 118 executing on a client device 102 may, in effect, engage with his or her own logical instance of an automated assistant 120. For the sakes of brevity and simplicity, the term “automated assistant” as used herein as “serving” a particular user will refer to the combination of an automated assistant client 118 executing on a client device 102 operated by the user and one or more GM-powered automated assistant components 119. It should also be understood that in many cases, automated assistant 120 may respond to a request from any user regardless of whether the user is actually “served” by that particular instance of automated assistant 120.

The client devices 102 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device), a robot, etc. Additional and/or alternative client computing devices may be provided.

In various implementations, an individual communicates with automated assistant 120 utilizing any one of a plurality of client computing devices that collectively form a coordinated ecosystem of client computing devices. In some cases, the coordinated ecosystem of client devices may be linked to the individual via a user profile of the individual that is associated with, for example, the individual's email address. In some such implementations, the individual's user-specific conditioning data (USCD) may also be linked with this same profile, so that that the individual's USCD may be used when the individual operates any client device of their coordinated ecosystem to interact with automated assistant 120, or more generally, to interact with generative model(s).

Automated assistant 120 engages in human-to-computer dialog sessions with a user via user interface input and output devices of one or more client devices 102-1 to 102-N. To preserve user privacy and/or to conserve resources, in many situations a user must often explicitly invoke the automated assistant 120 before the automated assistant will fully process a spoken utterance. The explicit invocation of the automated assistant 120 can occur in response to certain user interface input received at the client devices 102. For example, user interface inputs that can invoke the automated assistant 120 via the client devices 102 can optionally include actuations of a hardware and/or virtual button of the client device 102. In some implementations, the automated assistant client may include a component 114 that is configured to capture the user's utterance and either convert it to text using text to speech (TTS) processing, or in some cases, convert the audio directly into semantically rich embeddings, e.g., using an end-to-end transformer-based architecture (with text being generated, if at all, as a byproduct). The component 114 may also include speech to text (STT) functionality for converting text (or embeddings) to synthetic audio such as speech. For example, textual content received from GM-powered automated assistant components 119 may be processed using the STT functionality of component 114 and output as audio content using one or more speakers.

Client devices 102-1 to 102-N may also include user-specific conditioning data (USCD) engines 104-1 to 104-N and user interactions engines 108-1 to 108-N that are operably coupled, directly or indirectly, with user-specific conditioning (USCD) databases 106-1 to 106-N and user interactions databases 110-1 to 110-N, respectively. Additionally or alternatively, in some implementations, cloud-based instances of these components may be provided. For instance, there may be a cloud-based USCD engine 104′, a cloud-based USCD database 106′, a cloud-based user interactions engine 108′, and/or a cloud-based user interactions database 110′.

Anytime any of the reference numerals 104 to 110 are used herein without any additional context (e.g., “-1” or a single quote), that may refer to either the local instance (e.g., 104-1, 106-1, 108-1, 110-1) or the cloud-based instance (e.g., 104, 106, 108, 110).

USCD engine 104 may be configured to build and/or maintain USCD for each user based on data received from user interactions engine 108 and/or from other sources, such as automated assistant client 118. USCD may be indicative of a wide variety of an individual's attributes, including but not limited to preferences, observed behavior, content of electronic correspondence, smart appliance configurations, user-centric coordinated ecosystems of computing devices, schedules, travel history and/or any combination thereof. As noted elsewhere herein, individuals may have complete control over which user interactions (and hence, which of their attributes) are incorporated into their USCD, and which user interactions are not.

USCD engine 104 may store USCD in USCD database 106 in various forms and/or modalities, such as natural language text, structured text such as extensible markup language (XML) or JavaScript Object Notation (JSON), semantically-rich embeddings/tokens, images, videos, and/or any combination thereof. In various implementations, USCD engine 104 may represent user interactions in USCD in different ways. For example, USCD engine 104 may incorporate data indicative of new user interactions into USCD in raw form, whereas previous user interactions may be summarized in the USCD as text/embeddings. In some instances, those new user interactions may be subsequently summarized into text/embeddings when convenient/during downtime. In some implementations, USCD engine 104 or other components herein may formulate USCD to be condensed relative to raw data from which it is derived. For instance, electronic correspondence and/or textual documents consumed by an individual may be summarized using generative model(s) into abridged textual summaries and/or encoded into reduced-dimensionality embedding(s) before being stored as USCD in database 106.

In some implementations, USCD stored in USCD database 106 may be associated with various metadata. This metadata may include, for instance, mappings between portions of the USCD and the underlying user interactions (e.g., raw data) that spawned those portions of the USCD, which are described elsewhere herein. Additionally or alternatively, in some implementations, the metadata associated with USCD may include timestamps of when, for instance, those portions were added to the USCD or last modified. In some instances, these timestamps may be used as mappings between portion(s) of the USCD and an underlying user interactions timeline that is stored, for instance, in user interactions database 110. The USCD metadata may additionally or alternatively include confidence measures associated with individual pieces of data. For instance, a search engine query seeking vegetarian restaurants may be assigned less confidence than an explicit statement from an individual that he or she is a vegetarian. This may be because, for instance, the search engine query is capable of multiple interpretations, such as the individual was seeking a restaurant for a vegetarian friend or colleague. The explicit statement is less ambiguous, and therefore may be assigned a greater confidence measure.

In many implementations, USCD engine 104 may be required to solicit explicit and/or implicit permission from individuals prior to storing data received from user interactions engine 108 as part of USCD in USCD database 106. For example, USCD engine 104-1 may cause client device 102-1 to audibly and/or visually prompt the individual to expressly indicate their willingness to have data provided as USCD by USCD engine 104 and/or user interactions engine 108 be stored by USCD engine 104 in USCD database 106. By opting into such use of their personal data, the individual's privacy and/or security in using such data is maintained. Additionally or alternatively, in some implementations, an individual's USCD may be encrypted before being transmitted to GM-powered automated assistant components 119 and/or shared with other components, such as the cloud-based USCD engine 104′ and corresponding cloud-based USCD database 106′, or the cloud-based user interactions engine 108′ and corresponding cloud-based user interactions database 110′.

In various implementations, and with the individual's express permission, user interactions engines 108 may be configured to monitor various types of user interactions between the individual and one or more computing devices 102-1 to 102-N, and store data indicative of relevant interactions in user interactions database 110. In other implementations, USCD engine(s) 104 may handle all functions attributed herein to user interactions engine(s) 108, and user interactions engine(s) 108 may be omitted.

As one example, user interactions engine 108 (or USCD engine 104 in some implementations) may monitor emails, text messages, and/or other forms of electronic content sent or received, e.g., via network 199, by user device 102-1. If the individual receives an email about a flight cancellation, user interactions engine 108 may store data indicative of this email in user interactions database 110. USCD engine 104 may use this data to update the individual's USCD in USCD database 106 to reflect the flight cancellation. Alternatively, USCD engine 104 may monitor emails and update USCD directly, and the user interactions engine 108 may be omitted. The flight cancellation might be used during a subsequent interaction between the individual and a generative model 126. For example, the individual might ask the automated assistant 120 “What is my travel schedule for next week?” The automated assistant 120, using generative model 126, would then be able to provide a more accurate and relevant response, taking into account the flight cancellation.

As another example, user interactions engine 108 (or USCD engine 104 in some implementations) may monitor search engine queries, search engine responses, automated assistant queries, automated assistant responses, and/or other forms of search results received, e.g., via network 199, by user device 102-1. As an example, if an individual searches for vegetarian restaurants, user interactions engine 108 may store data indicative of this query in user interactions database 110. USCD engine 104 may use data indicative of such a search query to update the individual's USCD in USCD database 106 to reflect the user's preference for vegetarian cuisine. The individual's preference for vegetarian cuisine, as it is reflected in the individual's USCD, might be used during a subsequent interaction between the individual and a generative model 126 by providing the individual with restaurant recommendations that are vegetarian-friendly. For example, if the individual asks, “What are some good restaurants near me?”, the generative model 126 could take into account the individual's preference for vegetarian cuisine and recommend restaurants that have a large selection of vegetarian dishes.

As yet another example, user interactions engine 108 (or USCD engine 104 in some implementations) may monitor content consumed, e.g., viewed, listened to, or otherwise experienced by a user device 102-1 to 102-N. For example, if a user watches an online video about a specific topic, user interactions engine 108 may store data indicative of this video in user interactions database 110. This data can then be used to update the user's USCD in USCD database 106 to reflect the user's interest in that topic. As another example, if a user listens to a podcast episode about a specific event, user interactions engine 108 (or USCD engine 104 in some implementations) may store data indicative of this podcast episode in user interactions database 110. USCD engine 104 may use this data to update the user's USCD in USCD database 106 to reflect the user's awareness of that event. If the user later asks the automated assistant 120 “What is the latest news about the event?”, the automated assistant will be able to provide more relevant information based on the user's awareness of the event from the podcast episode.

As yet another example, user interactions engine 108 (or USCD engine 104 in some implementations) may monitor user preferences and/or other user feedback explicitly submitted by the user, e.g., via automated assistant client 118 or otherwise. User preferences that might be captured and incorporated into the USCD include, but are not limited to, preferences for specific types of content (e.g., news, entertainment, music, etc.), preferences for specific topics or genres (e.g., sports, cooking, history, etc.), preferences for specific languages, preferences for specific styles or formats (e.g., formal, informal, casual, etc.), preferences for specific levels of detail or complexity, preferences for specific types of responses (e.g., factual, creative, humorous, etc.), preferences for specific sources of information, preferences for specific types of interactions (e.g., text-based, voice-based, visual, etc.), preferences for specific levels of personalization, preferences for specific levels of privacy, preferences for specific types of assistance (e.g., task-oriented, informational, conversational, etc.), preferences for specific time periods or contexts (e.g., work, home, travel, etc.), preferences for specific individuals or groups (e.g., family, friends, colleagues, etc.), and/or preferences for specific locations or settings.

As yet another example, user interactions engine 108 (or USCD engine 104 in some implementations) may monitor changes made to smart appliance configuration(s) by user device(s) 102-1 to 102-N. Suppose a user adds a new smart light to their kitchen. User interactions engine 108 may store data indicative of this change in user interactions database 110. This data can then be used to update the user's USCD in USCD database 106 to reflect the new configuration of the user's smart appliances. The user's new smart light in the kitchen would be reflected in the user's USCD. When the user asks the automated assistant to “turn on all the kitchen lights” the automated assistant will now include the new smart light in its response, turning it on along with the other lights. Changes made to smart appliance configurations can take a variety of different forms, including but not limited to adding, modifying, and/or removing a smart appliance, installing or removing a software application that interacts with the smart appliance (e.g., a security application, a smart home application, a “smart” thermostat application, etc.), modifying and/or adjusting settings and/or parameters of the smart appliance, modifying and/or adjusting settings and/or parameters of the software application that interacts with the smart appliance, etc.

As yet another example, user interactions engine 108 (or USCD engine 104 in some implementations) may monitor locations and/or trajectories of locations accumulated with prior user consent by one or more client devices 102-1 to 102-N. For example, if an individual frequently visits a particular neighborhood, their USCD may include a record of these visits. If the individual later asks the automated assistant 120, “I want to try something new,” the automated assistant could use the individual's location history to suggest locations outside of their usual neighborhood. If the individual later decides to opt out of having their locations tracked, accumulated locations may be deleted from the individual's user interactions database 110. This may trigger implementations described herein to follow mappings from those deleted trajectories to the individual's USCD, where corresponding portion(s) of the USCD can likewise be deleted. Consequently, if the individual later asks the automated assistant 120, “I want to try something new,” the individual's past travels will no longer be accounted for in the generative model response.

Similar to USCD engine 104, in various implementations, user interactions engine 108 may be required to solicit explicit and/or implicit permission from an individual prior to monitoring user interaction(s) between the individual and computing devices 102-1 to 102-N and storing data indicative thereof in user interactions database 110. For example, user interactions engine 108 may cause client device 102-1 to audibly and/or visually prompt the individual to expressly indicate their willingness to have data provided as user interaction(s) by user interactions engine 108 be stored in user interactions database 110. By being able to opt in and/or out of such use of their personal data, the individual's privacy and/or security in using such data is maintained. In some implementations, an individual's user interaction(s) may be stored only in local user interactions database 110, or may be encrypted before being transmitted to GM-powered automated assistant components 119 and/or shared with other components.

GM-powered automated assistant component(s) 119 may include a TTS component 116, an STT component 117, a prompt assembly engine 122, a GM selection engine 124, a classifier 125, a GM output generator 128, a cloud-based USCD engine 104′and corresponding database 106′, and a cloud-based user interactions engine 108′ and corresponding user interactions database 110′. TTS component 116 may be configured to leverage the virtually limitless resources of the cloud computing system to convert textual data (e.g., natural language responses formulated by automated assistant 120) into computer generated speech output. In some implementations, TTS component 116 may provide the computer generated speech output to client device 102 to be output directly, e.g., using one or more speakers. TTS component 116 may use any appropriate speech synthesis technique to generate computer generated speech output from textual data including, but not limited to, concatenative synthesis, unit selection synthesis, diphone synthesis, domain-specific synthesis, formant synthesis, Hidden Markov Model (HMM)-based synthesis (e.g., Gaussian mixture core network synthesis), sinewave synthesis, or any combination thereof. In some implementations, the TTS component 116 may be implemented using an end-to-end transformer-based architecture.

STT component 117 may be configured to convert a spoken utterance into text data. In some implementations, STT component 117 may convert an utterance into multiple text segments, e.g., phonemes, word pieces, etc., that are string of characters corresponding to the utterance. STT component 117 may convert the utterance into text data using various speech recognition techniques, such as hidden Markov model (HMM) techniques, dynamic time warping (DTW)-based techniques, neural network-based techniques, or other techniques. In some implementations, the STT component 117 may be implemented using an end-to-end transformer-based architecture.

Prompt assembly engine 122 may be configured to assemble generative model prompts (or “context”) that can then be used by GM selection engine 124 to select one or more GMs from GM database 126, and that can be used by GM output generator 128 to generate generative model output. Prompt assembly engine 122 may assemble generative model prompts from various data sources, such as a user's explicit or implicit generative model query. An explicit generative model query may be issued via the user typing or speaking the query. An implicit generative model query may be issued automatically, e.g., in response to various events that may occur in a software application, in response to particular sensor data, etc.

In addition to an individual's explicit or implicit generative model query, prompt assembly engine 122 may assemble other data into a generative model prompt. For example, prompt assembly engine 122 may assemble data indicative of the individual's USCD, received from cloud-based USCD engine 104′ or a local USCD engine 104-1 to 104-N into the generative model prompt. In some implementations, a cloud-based USCD engine 104′ may obtain this USCD from database 106-1 of client device 102-1 and may temporarily store it in a cloud-based USCD database 106′. Additionally or alternatively, cloud-based USCD engine 104′may store individuals'USCD data in cloud-based USCD database 106′on a long term basis, while taking steps to ensure the privacy and security of the individuals'USCD. In some such implementations, the individuals may be required to provide express permission before their USCD can be stored in cloud-based USCD database 106′. Additionally or alternatively, in some implementations, USCD stored in database 106′ (or locally at 106) may be stored in a form that is not readily interpretable by humans, such as in continuous embedding form, encrypted form, hashed form, etc.

As noted above, GM selection engine 124 may be configured to select one or more generative models 126 that are suitable for generating content responsive to, for instance, an individual's generative model query (or even to a generic search query), to an implicit query, and/or to a request to update an individual's USCD based on new user interaction(s). In some implementations, GM selection engine 124 may utilize a classifier 125 to identify a generative model that is most likely to accurately and efficiently respond to a generative model query provided by automated assistant 120 and an individual that provided the generative model query. Such a classifier may itself be a generative model (e.g., an LLM), or it may be another type of machine learning model that is trained to classify or otherwise generate scores for different available generative models 126. As one example, if an individual's query includes both text and an image (e.g., “modify this image to delete the clouds”), the GM selection engine 124 may select a generative model that is suitable for generating synthetic image data, such as a diffusion model. Additionally or alternatively, GM output generator 128 may include a plurality of generative model agents, each configured to perform different task(s) using different generative models, and the GM selection engine 124 may select the most suitable GM agent.

GM output generator 128 may be configured to process a prompt using one or more generative models selected by GM selection engine 124 from GM database 126 (GM database and generative models themselves will both be interchangeably referenced using 126) to generate content that is responsive to, for instance, a generative model query from automated assistant client 118 at a client device 102, or to an implicit query to update an individual's USCD based on new user interaction(s). To this end, GM output generator 128 may have access to one or more generative models in database 126, and may apply those generative model(s) that are selected by GM selection engine 124.

GM database 126 may include a variety of generative models, such as foundation models, fine-tuned models, and task-specific models. Foundation models may be pretrained on large datasets of various types of data, such as text, code, images, videos, audio, etc. Foundation models can be used for a wide range of tasks. Fine-tuned models are foundation models that have been further trained on a specific dataset, such as a dataset of customer service conversations or a dataset of medical records. Task-specific models are designed for a specific task, such as generating code, translating languages, or writing different kinds of creative content. Generative models can be single-modal or multi-modal. Single-modal models process and generate data of a single type, such as text or images. Multi-modal models process and/or generate data of multiple types, such as text and images, or text and audio. Generative models may or may not be transformer-based, and may be encoder-only, decoder-only, or encoder-decoder. Encoder-only models take an input and produce a representation of that input. Decoder-only models take a representation and produce an output. Encoder-decoder models combine both encoder and decoder components. Some generative models that generate non-textual data may include, for instance, stable diffusion models.

The number of parameters in a generative model can vary significantly depending on the model's complexity and the resources available for its implementation. On a resource-constrained client device like 102, the model may have a smaller number of parameters to optimize performance and reduce memory usage. This is because client devices often have limited processing power and memory compared to cloud servers. In contrast, a generative model implemented on a cloud server like 119 can have a much larger number of parameters due to the availability of extensive computing resources. This allows for more complex models with higher accuracy and capabilities. The choice of parameter size is a trade-off between model performance and resource constraints. For example, on a client device with limited resources, a generative model might have 100 million parameters, while a server-based model could have billions of parameters, enabling more complex and accurate results. Another example is a client device model with 500 million parameters, compared to a server model with 100 billion parameters, showcasing the significant difference in scale and capabilities.

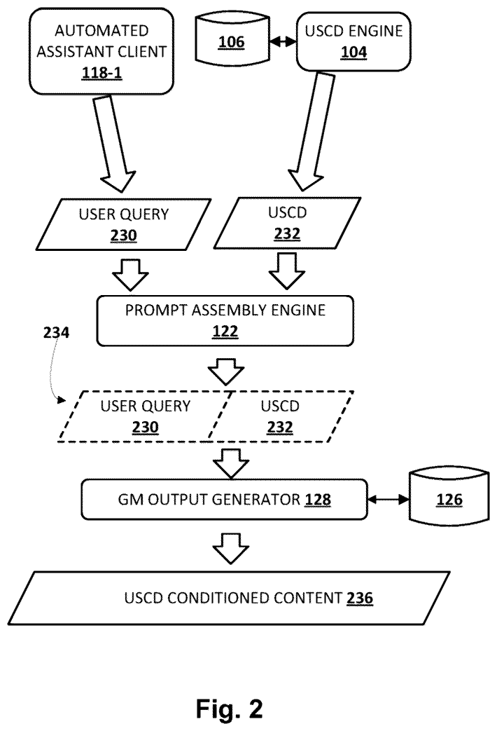

FIG. 2 schematically depicts an example of how various components of FIG. 1 may cooperate to conduct selected aspects of the present disclosure. Beginning at top, USCD engine 104-1 and automated assistant client 118-1 of client device 102-1 may provide, respectively, data indicative of a user-specific conditioning data (USCD) 232 and a user query 230 to prompt assembly engine 122. Prompt assembly engine 122 may then assemble the USCD 232 and the user query 230 into a generative model prompt 234. While not shown in FIG. 2 for the sake of brevity and simplicity, this generative model prompt 234 may be provided to GM selection engine 124, and GM selection engine 124 may select appropriate generative model(s) 126 and/or GM agents for processing this generative model prompt 234.

Moreover, various other information may or may not be assembled into generative model prompt 234 by prompt assembly engine 122. This other information may, for instance, identify tools (e.g., installed application, web applications (RESTful or RPC)) that are available to perform various functions (e.g., controlling smart appliances at a home or in a vehicle). Additionally or alternatively, this other information may include system instructions (e.g., not provided by the user) on how USCD should be used to personalize or otherwise condition the generative model output. For instance, the system instructions may include a natural language statement such as “When responding to the user's query, make sure to take into account this summary of the user, including the user's preferences, attributes, etc.” In some implementations, the system instructions may include additional requests designed to avoid various negative outcomes. For example, the system instructions may include a request such as “Medical data of the user should not be disclosed to anyone other than the user. Accordingly, don't directly incorporate the user's medical data into your response. At most, allow the user's medical data to influence other output you generate, without explicitly mentioning the medical data itself.”

Referring back to FIG. 2, prompt assembly engine 122 (or GM selection engine 124) may provide generative model prompt 234 to GM output generator 128. GM output generator 128 may then input the generative model prompt 234 into one or more generative models of GM database 126 to generate output that includes USCD-conditioned content 236. USCD conditioned content 236 may include content that is both responsive to user query 230 and conditioned upon USCD 232.

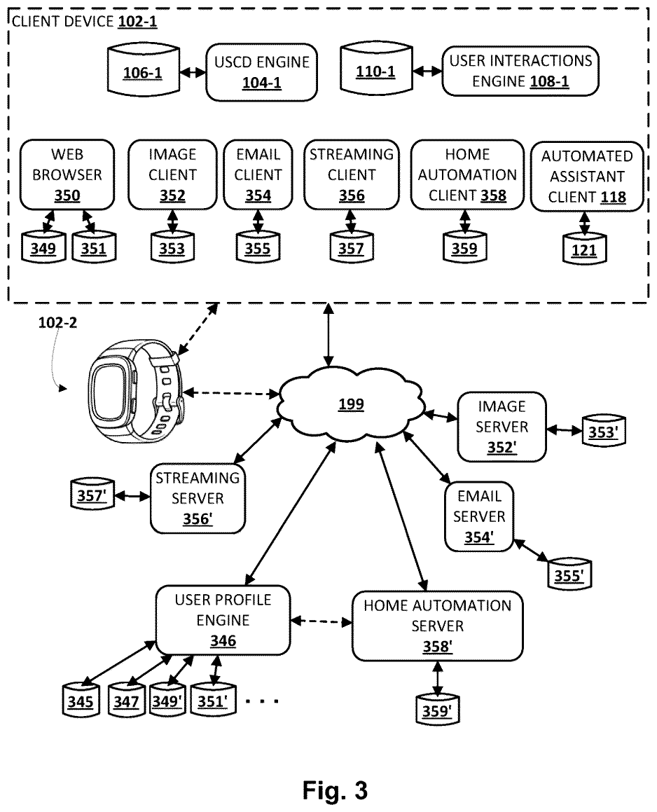

FIG. 3 schematically depicts an example of how user interactions from a variety of different sources may be accessible to components such as local user interactions engine 108-1 (or a cloud-based user interactions engine 108′ such as that depicted in FIG. 1), USCD engine 104-1 to 104-N (or cloud-based USCD engine 104′ in FIG. 1), and/or to a user profile engine 346, to update USCD based on changes to user interactions made by individuals. The components depicted in FIG. 3 are for illustration only and are not meant to be limiting.

Additional components not depicted in FIG. 3 may additionally or alternatively maintain user interactions that can be incorporated into and/or deleted from USCD as described herein. Additionally, one or more components depicted in FIG. 3 may be omitted and/or combined with other components of FIG. 3. In FIG. 3, a single client device 102-1 is depicted as being operably coupled to various cloud-based components via one or more networks 199, but it should be understood that numerous other client devices would likely be present.

Client device 102-1 may include various local sources of user interactions. A web browser 350 may be operable by an individual (not depicted) to navigate the web and consume documents such as web pages, videos, images, music, etc. Web browser 350 may include, in the form of a database and/or log(s), a search history 349 and/or a browsing history 351 (which may include bookmarks in some cases) of an individual. An image client 352 may be operable by the individual to view and/or edit digital images and/or videos captured or otherwise obtained by the individual. Image client 352 may include a local image database 353 that may include, for instance some number of recently captured images, images captured using a vision sensor onboard the same client device 102-1, etc.

Email client 354 may be operable by the individual to send and/or receive email messages. Email client 354 may include a local email database 355 that may include, for instance, previously received and/or sent email messages and/or message threads. Streaming client 356 may be operable by the individual to stream various types of content, such as audio content (e.g., music, podcasts), video content (e.g., movies, television shows), and so forth. Streaming client 356 may include a local streaming database 357 that may include, for instance, recently streamed content by the individual, content scheduled for streaming to the individual, most frequently streamed content by the individual, streaming preferences (e.g., “likes” or “dislikes”, preferred genres, favorite actors/directors/artists), and so forth.

Home automation client 358 may be operable by the individual to control access to and/or automation of different kinds of home technology and systems. Home automation client 358 may include a local device control database 359 that may include, for instance, recently invoked commands by the individual, preferred device settings for different items of home technology and/or home automation, home automation configuration for various smart appliances, and so forth. Automated assistant client 118, which was described previously, may also maintain a log 121 of generative model queries and, where applicable, corresponding generative model responses.

Not all sources of user interactions are necessarily stored locally at client devices 102-1 to 102-N. In some implementations, various cloud-based resources may include user interactions that can be selectively incorporated into and/or removed from USCD. For example, a user profile engine 346 may be configured to detect and/or maintain a user profile for an individual, e.g., in association with their email address. A user profile may include, for instance, general user profile data 345 such as an individual's name, age, address, general preferences explicitly provided by the individual, configuration data for a coordinated ecosystem of client devices registered to and/or under the control of a particular user, and so forth.

In implementations in which the individual uses one or more client devices equipped with physiological sensors, such as a fitness watch 102-2, physiological readings 347 may be available as user interactions. Physiological readings may include, for instance, heart rate, blood pressure, body temperature, sleep patterns, gait, and/or other biometric data. While not shown in FIG. 3, in some such implementations, physiological readings may be stored locally on client device 102-1, e.g., in a database associated with a fitness application (not depicted) or other software installed on client device 102-1. As indicated by the dashed arrows, fitness watch 102-2 (and other similar client devices) may be communicatively coupled directly to another client device (e.g., via Bluetooth to client device 102-1) or to one or more networks (e.g., via Wi-Fi or cellular connection).

Some individuals may opt to backup or otherwise surface their local search histories 349 and/or browsing histories 351 (particularly user-created bookmarks) to the cloud. This allows the individuals to, for instance, synchronize, across web browsers installed on multiple different client devices, search histories, browsing histories, bookmarks, and/or other data such as browser cache, browser plug-ins and/or extensions, cookies, and so forth. In some such implementations, this type of data may be stored, e.g., by user profile engine 346, in cloud-based databases (e.g., logs) of search histories 349′ and/or browsing histories 351′. In various implementations, user interactions engine 108-1 or other components may have access to these cloud-based data resources.

Similarly, other local components (e.g., 350-358, 118) may interact with and/or have counterpart cloud-based components. For example, an image server 352′ may include a cloud-based image database 353′ that includes images captured by individuals, e.g., in association with the individuals'accounts (e.g., managed by user profile engine 346 in some cases). In some implementations, image client 352 may synchronize some or all images in local image database 353 with cloud-based image database 353′. Given the virtually limitless resources of the cloud, in some cases, cloud-based images database 353′ may store and/or organize a superset of images that is considerably larger than a subset of those images stored locally at image database 353. In some implementations, captions may be generated for these images, e.g., automatically or manually using a VLM or other object-detection machine learning model. These captions may be detected by user interactions engine 108 and incorporated into USCD by USCD engine 104.

Email client 354 may interact with an email server 354′. Email server 354′ may be configured to store and/or organize, in a cloud-based email database 355′, a superset of email messages that is synchronized with and/or considerably larger than a subset of those messages stored locally to email database 355. Streaming client 356 may interact with a streaming server 356′. Streaming server 356′ may store and/or organize similar data as was stored in local streaming database 357. For example, local database 357 may store data that is associated with the particular individual, whereas cloud-based streaming database 357′ may store data that is associated with a whole population of users, including the individual.

A home automation server 358′may operate similarly, hosting home automation data associated with a population, including the individual who operates local home automation client 358 on client device 102-1, in a cloud-based home automation database 359′. As indicated by the dashed lines, in some cases, the home automation server 358′ and user profile engine 346 may cooperate and/or may even be combined. For example, cloud-based home automation database 359′ may simply be another database that is accessible to user profile engine 346.

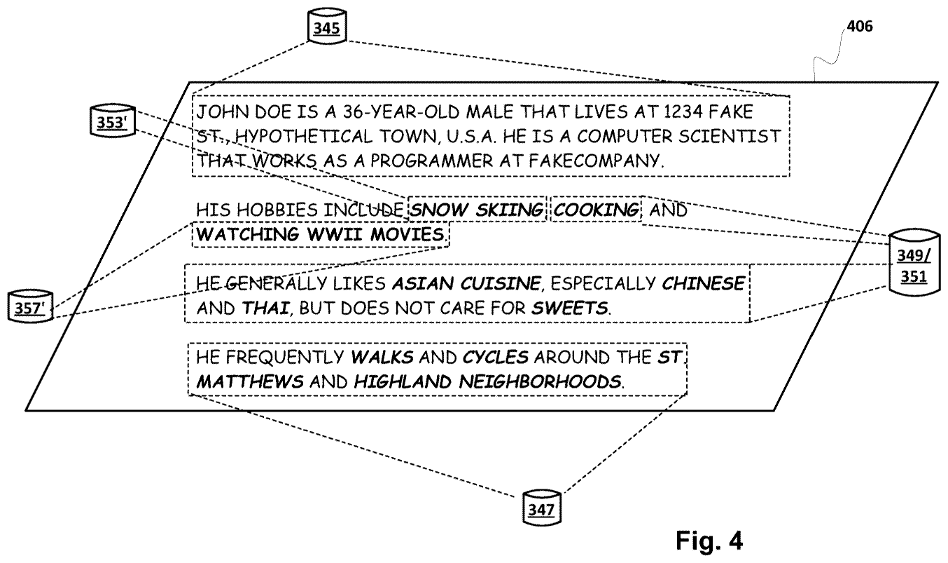

FIG. 4 schematically depicts an example of USCD 406 and mappings between portions of USCD 406 and various sources data indicative of user interactions. These mappings may enable changes made to user interactions (e.g., in the various sources depicted in FIG. 3) to be reflected in USCD 406. In this example, USCD 406 takes the form of a natural language summary that describes various aspects of an individual named John Doe, a 36-year-old programmer from Hypothetical Town. However, not all USCD need be in the form of natural language. USCD may be expressed, coded, and/or stored in a variety of forms, such as using tokens and/or reduced dimensionality embeddings, images, visual indicia (e.g., quick review (QR) codes), structured data (e.g., relational databases, JSON files, XML files), and so forth.

Starting at top, data indicative of user interaction(s) stored in general user preferences database 345 may form the basis of, and therefore be mapped to, portion(s) of USCD. This includes basic information, such as his name (John Doe), age (36), address (1234 Fake St., Hypothetical Town, U.S.A.), profession (computer scientist), role (programmer), and employer (FAKECOMPANY). This mapping is indicated by the dashed lines from user preferences database 345 to the top portion (paragraph) of USCD 406. Mappings such as this may be represented and/or stored various forms, such as using pointers, hash functions, relational databases, etc.

In some implementations, mappings may be represented as identifiers/hash values in a timeline of user interaction events that is managed, e.g., by user interactions engine 108 and stored in database 110. In some cases, timestamps of the user interactions may be stored in the timeline as well. In other implementations, a mapping may be represented as (e.g., take the form of) instruction(s) for retrieving user interaction(s) from a structured data source, such as a relational database, spreadsheet, etc. In some such implementations, the instruction(s) may be composed using a domain-specific language (DSL), such as a high level programming language source code (e.g., instructions to make an API call), or using the Structured Query Language (SQL) or similar.

As an example, when a portion of USCD 406 is populated or added to represent attribute(s) of an individual, a mapping may be stored in association with that portion/those attributes, e.g., in the same area of memory as USCD 406, in a separate database or log, as metadata, etc. That mapping may take the form of, for instance, a SQL instruction to retrieve data corresponding to the underlying user interaction(s) that spawned the individual's attributes. Suppose general user preferences database 345 is a relational database that is accessible, e.g., by user profile engine 346, using SQL commands. A mapping between the individual's “role” (programmer) and a corresponding portion of USCD 406 may be formulated as a SQL command such as “SELECT role FROM users WHERE name=‘John Doe’”. This mapping may be stored, e.g., as hidden data within USCD 406 and/or as separate metadata that is associated with USCD 406. Thereafter, if the individual's role in database 345 is updated (e.g., to “retired” or “manager”), that change may be propagated to USCD 406 by executing the SQL command forming the mapping, and replacing the relevant portion of USCD 406 with the individual's new role.

In some implementations, a database trigger may be generated, e.g., by user interactions engine 108 and/or by USCD engine 104, whenever data indicative of new/updated user interaction(s) is used by USCD engine 104 to update USCD 406. A database trigger may be a piece of code (e.g., script) that is executed automatically when particular events occur in a database. In some implementations, these database triggers may be created to update USCD 406 automatically whenever triggering events occur, e.g., when an individual modifies or deletes data indicative of user interaction(s) from a respective relational database. Using the above example, when the individual's role of “programmer” was input into general user preferences database 345, a database trigger may have been set to be triggered the next time the individual's role is changed. This database trigger, when executed, may modify USCD 406, e.g., by requesting that USCD engine 104/104′ update the “role” attribute portion of USCD 406 from “programmer” to whatever the new role in database 345 is (e.g., manager, retired).

In some implementations, such a database trigger may include code that explicitly identifies a particular portion of USCD 406 (e.g., beginning and ending memory portions, beginning and end of sentence(s) describing the attribute) and the data that is to be used to repopulate that particular portion. In other implementations, such a database trigger may include a generative model query that requests that the particular portion of USCD 406 be updated with the new data. One or more generative models 126 can be applied, e.g., by GM output generator 128 or another component, to intelligently replace the relevant portion of USCD 406 (e.g., replace natural language with new natural language). In some implementations, a database trigger may include an application programming interface (API) call, such as a remote procedure call (RPC) or representational state transfer (REST) API.

Referring back to FIG. 4, various hobbies of John Doe are set forth in the second paragraph of USCD 406. As indicated by the dashed lines representing mappings, the attribute of “snow skiing” is mapped to one or more individual photos depicting snow skiing that are stored in cloud-based images database 353′. This may indicate that John Doe has a relatively large number of images stored in cloud-based images database 353′ (and/or on local images database 353) that depict John Doe and/or others engaged in snow skiing. Such topics may be detected, for instance, by processing images to generate captions, e.g., using a VLM. If John Doe were to later remove these images of snow skiing, e.g., because he gave up the sport, those mappings may be used, e.g., by USCD engine 104, to remove the hobby of “snow skiing” from USCD 406.

Different dashed lines in FIG. 4 represent mappings between his hobbies of “cooking” and “watching WWII movies.” In the case of “cooking,” the relevant portion of USCD 406 is mapped to John Doe's search history 349 and/or browsing history 351. In the case of “watching WWII movies,” the relevant portion of USCD 406 is mapped to cloud-based streaming database 357′ (or, in some cases, to local streaming database 357). Additional preferences of John Doe for Asian Cuisine, including Chinese and Thai cuisine, as well as an aversion to sweets, are set forth in the next paragraph of John Doe's USCD 406. As indicated by the dashed lines, the relevant portion of USCD 406 containing these preferences is mapped to John Doe's search history 349 and/or browsing history 351.

John Doe's travel habits are described in the last paragraph of USCD 406. These travel habits indicates that he likes to walk and cycle through the Highland and St. Matthews neighborhoods. As indicated by the dashed lines, the relevant portion of USCD 406 is mapped to physiological data 347, such as one or more of John Doe's travel trajectories accumulated over time with his express consent. These travel trajectories may be accumulated in some implementations by client device 102-1 over time by GPS data (e.g., GPS coordinates) obtained by client device 102-1 at various times. If John Doe subsequently deletes (or blocks access to) one or more travel trajectories from physiological data, e.g., because he wants to increase his sense of privacy, the mappings between the last paragraph of USCD 406 and physiological database may be used to delete those travel habits from USCD 406.

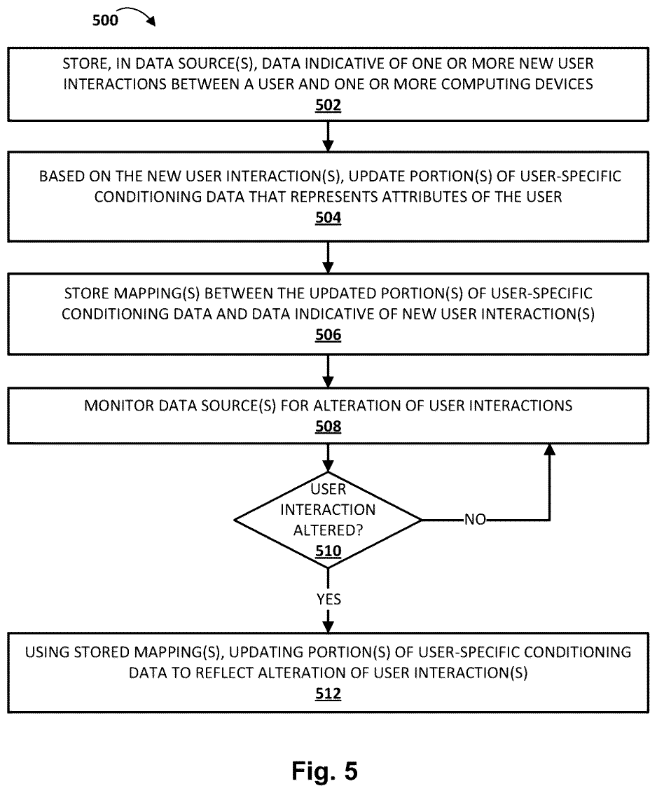

FIG. 5 is a flowchart 500 illustrating an example method of performing selected aspects of the present disclosure. The operations of method 500 may be performed by a system configured with selected aspects of the present disclosure. Such a system may include all or parts of computing devices 102-1 to 102-N and/or server 119. The order of operations shown in flowchart 500 is not meant to be limiting; the operations can be reordered, and some operations may be omitted or added.

At block 502, data indicative of one or more new user interactions between a user and one or more computing devices 102-1 to 102-N is stored. This operation may be performed by the user interactions engine 108-1 to 108-N of FIG. 1. The new user interactions may comprise various types of data, including but not limited to electronic correspondence, documents, software applications, digital images, content purchases, preferences, generative model output rejections, social media posts, location trajectories, or physiological sensor readings, to name a few. The data may be stored in the user interactions database 110-1 to 110-N. In some implementations, the data may be stored in a structured format, such as a relational database, allowing for efficient retrieval using a DSL such as SQL.

At block 504, based on the one or more new user interactions, one or more portions of user-specific conditioning data (USCD) 232/406 that represents attributes of the user are updated. This operation may be performed by the USCD engine 104-1 to 104-N, or by cloud-based USCD engine 104′, e.g., using data from the user interactions database 110-1 to 110-N. The USCD 232/406 may be stored in a local USCD database 106-1 to 106-N and/or cloud-based USCD database 106′. As noted elsewhere herein, USCD 232/406 may be operable to condition content generated by generative models 126 based on the attributes of the user, such that the generated content is tailored to the user.

At block 506, one or more mappings between the one or more updated portions of the USCD and the data indicative of the one or more new user interactions are stored. This operation may be performed by the USCD engine 104-1 to 104-N and/or the user interactions engine 108-1 to 108-N. These mappings may be token-based, stored in a database associated with a user identifier, and/or may include instructions for retrieving user interactions from structured data, using hash functions, or using pointers. In some implementations, mappings may be implemented as database triggers that are set to automatically update USCD 232/406 based on changes made to user interactions stored in databases.

In some implementations, at block 508, various data sources, such as those depicted in FIG. 3, may be monitored for alteration of user interactions. For example, user profile engine 346 may allow an individual to directly manipulate their user profile, e.g., to change job titles, preferences, etc. Additionally, changes an individual makes to his or her search history or browsing history may be propagated, e.g., by user interactions engine 108-i, from local databases 349, 351 to cloud-based databases 349′, 351′. Similarly, if an individual operates streaming client 356 to make changes to local streaming database 357, the corresponding cloud-based streaming database 357′ may be updated accordingly. It should be noted, additionally, that when database triggers or other similar mechanisms are set to automatically update USCD 232/406 when user interaction(s) are altered, the monitoring operation of block 508 may include monitoring for triggering events associated with database triggers.

Based on the monitoring of block 508, at block 510, a determination may be made of whether user interaction(s) have been altered. The alteration may be a deletion, modification, or addition of data. If the answer is no, then method 500 may proceed back to block 508, and the monitoring may continue. If the answer at block 510 is yes, on the other hand, then method 500 may proceed to block 512. At block 512, in response to the determination at block 510, and using one or more of the mappings stored at block 506, one or more of the portions of USCD 232/406 may be updated to reflect the alteration of the one or more new user interactions. This operation may be performed by the USCD engine 104-1 to 104-N, using the stored mappings to identify the relevant portions of USCD 232/406 to update.

The update may involve deleting, modifying, or adding data to USCD 232/406, ensuring that USCD 232/406 accurately reflects the individual's current interactions, behaviors, etc. Consequently, future generative model responses provided in response to generative model queries issued by the individual, e.g., using automated assistant client 118, may be tailored to the attributes of the individual. In the case of deletion, in some implementations, any pertinent information in USCD 232/406 may be deleted. In the event this results in more information being deleted than the individual anticipated, the individual may have an opportunity to restore the information that was deleted from USCD 232/406, e.g., from a locally stored backup that may be stored/cached temporarily and/or permanently in memory local to a client device. Additionally or alternatively, new user interactions between the individual and computing device(s) that are detected over time may trigger the re-insertion of the same or similar information into USCD 232/406.

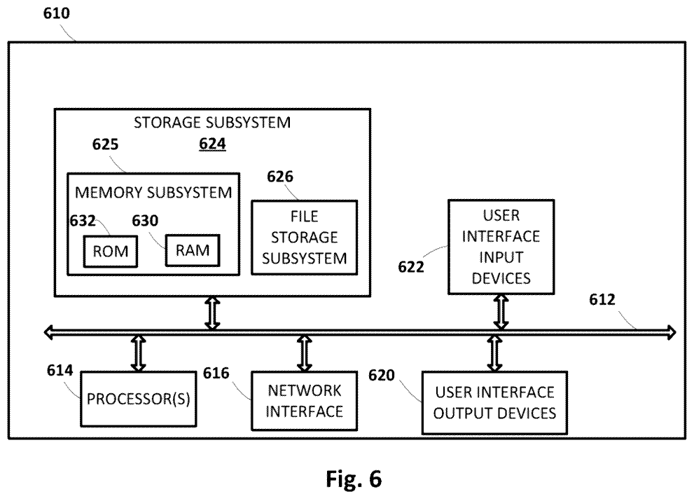

FIG. 6 is a block diagram of an example computer system 610. Computer system 610 typically includes processor(s) 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 622 may include any device for inputting information into computer system 610.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 620 may include any device for outputting information from computer system 610 to the user or to another machine or computer system.

Storage subsystem 624 stores programming and data constructs that provide the functionality of some or all of the modules described herein. For example, the storage subsystem 624 may include the logic to perform selected aspects of the method of FIG. 5. These software modules are generally executed by processor(s) 614 alone or in combination with other processors. Processor(s) 614 may take various forms, such as a central processing unit (CPU), a graphics processing unit (GPU), a tensor processing unit (TPU), a neural processing unit (NPU), and so forth.

Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual's discretion.

In various implementations, a method is provided for updating user-specific conditioning data (USCD) based on alterations to user interactions. Data indicative of new user interactions between a user and one or more computing devices may be stored. Based on these interactions, portions of the USCD, which represents user attributes and conditions a generative model, may be updated. Mappings between the updated USCD portions and the interaction data may be stored. Data sources may be monitored for alterations to user interaction data. In response to detecting such alterations, and using the stored mappings, portions of the USCD may be updated to reflect the alterations.

In various implementations, each mapping between USCD portions and interaction data may be token-based. In various implementations, each mapping may be stored in a database associated with a user identifier. In various implementations, mappings may include instructions for retrieving interactions from structured data, such as a relational database, potentially using a domain-specific language like SQL. In various implementations, mappings may include a hash function or a pointer. In various implementations, mappings may include a database trigger.

In various implementations, new user interactions may include electronic correspondence, accessed documents, installed software applications, application changes, application setting changes, device configuration changes, security/privacy configuration changes, captured/altered digital images, content purchases, explicitly provided preferences, rejected generative model output, social media posts, location trajectories, or physiological sensor readings. In various implementations, new user interactions may include commissioning, configuring, or decommissioning smart appliances. In various implementations, determining altered interactions may be based on monitoring data sources, and may comprise determining that interactions have been deleted.

In various implementations, a method is provided for updating USCD based on monitoring data sources for alterations to data indicative of user historical interactions. Upon determining that interaction data has been altered, and using stored mappings between the interaction data and USCD portions, the USCD portions may be updated to reflect the alteration.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented using one or more processors, comprising:
storing data indicative of one or more user interactions between a user and one or more computing devices in one or more data sources;
based on the one or more user interactions, updating one or more portions of user-specific conditioning data that comprises natural language text that describes attributes of the user, wherein the user-specific conditioning data is maintained in memory accessible to one or more applications to subsequently condition a generative model to generate output that is tailored to one or more of the attributes of the user;
storing one or more mappings between the one or more updated portions of the user-specific conditioning data and the data indicative of the one or more user interactions in the one or more data sources;
detecting an alteration of one or more of the user interactions has been altered;
in response to the detecting, and using one or more of the mappings as a reverse lookup to one or more of the data sources, updating one or more of the portions of the user-specific conditioning data to reflect the alteration of the one or more user interactions; and
causing the user-specific conditioning data to be assembled into a prompt that is applied as input across the generative model to generate the output that is tailored to one or more of the attributes of the user.

2. The method of claim 1, wherein each of the mappings between the one or more portions of the user-specific conditioning data and data indicative of the one or more new user interactions is token-based.

3. The method of claim 1, wherein each of the mappings between the one or more portions of the user-specific conditioning data and data indicative of the one or more new user interactions is stored in a database in association with an identifier of the user.

4. The method of claim 1, wherein one or more of the mappings comprises one or more instructions for retrieving one or more of the new user interactions from structured data.

5. The method of claim 4, wherein the structured data comprises a relational database.

6. The method of claim 5, wherein the one or more instructions are composed using a domain-specific language.

7. The method of claim 6, wherein the domain-specific language comprises a structured query language (SQL) instruction to retrieve data corresponding to one or more underlying user interactions that spawned one or more of the user's attributes.

8. The method of claim 1, wherein one or more of the mappings comprises a hash function.

9. The method of claim 1, wherein one or more of the mappings comprises a pointer.

10. The method of claim 1, wherein one or more of the mappings comprise a database trigger.

11. The method of claim 1, wherein one or more of the new user interactions comprises one or more of:
email sent or received by the user using one or more of the computing devices;
a document accessed by the user using one or more of the computing devices;
a software application installed on one or more of the computing devices and used by the user;
a change to an installed software application on one or more of the computing devices and used by the user;
a change made to a software application settings or functionality on one or more of the computing devices and used by the user;
a change made to a computing device configuration on one or more of the computing devices and used by the user;
a change made to a security or privacy configuration of a resource controlled by the user;
one or more digital images captured or altered by the user;
one or more content purchases by the user;
rejection of generative model output provided to the user based on the user-specific conditioning data;
one or more social media posts of the user;
one or more location trajectories accumulated by one or more of the computing devices; or
one or more readings from one or more physiological sensors worn by the user.

12. The method of claim 1, wherein the one or more new user interactions comprise one or more of:
commissioning a new smart appliance into a coordinated ecosystem of smart appliances associated with the user;
altering a configuration of a smart appliance within the coordinated ecosystem; or
decommissioning a smart appliance from the coordinated ecosystem.

13. The method of claim 1, further comprising monitoring one or more data sources, wherein determining that one or more of the new user interactions has been altered is based on the monitoring.

14. The method of claim 1, wherein determining that one or more of the new user interactions has been altered comprises determining that one or more of the new user interactions has been deleted.

15. A method implemented using one or more processors, comprising:
monitoring one or more data sources for alterations made to data, stored in the one or more data sources, that is indicative of one or more user historical interactions between a user and one or more computing devices, wherein the one or more data sources include one or more of:
physiological readings from one or more physiological sensors worn by the user,
one or more location trajectories accumulated by one or more of the computing devices, or
a coordinated ecosystem of smart appliances associated with the user;
based on the monitoring, determining that data indicative of one or more user interactions has been altered;
in response to the determining, and using one or more stored mappings between data indicative of user interactions stored in one or more of the data sources and one or more portions of user-specific conditioning data that represents attributes of a user, updating the one or more portions of the user-specific conditioning data to reflect the alteration of the one or more user interactions in the one or more data sources, wherein the user-specific conditioning data is operable to condition a generative model to generate output that is tailored to one or more of the attributes the user; and
causing the user-specific conditioning data to be assembled into a prompt that is applied as input across the generative model to generate the output that is tailored to one or more of the attributes of the user associated with one or more of the physiological readings, location trajectories, or the coordinated ecosystem of smart appliances.

16. (canceled)

17. The method of claim 15, wherein determining that data indicative of one or more user interactions has been altered comprises determining that one or more of the user interactions has been deleted.

18. The method of claim 15, wherein monitoring one or more data sources for alterations made to data comprises applying database triggers that are set to automatically update one or more of the portions of the user-specific conditioning data based on changes made to data indicative of one or more user interactions stored in one or more of the data sources.

19. A system comprising one or more processors and memory storing instructions that, in response to execution of the instructions by the one or more processors, cause the one or more processors to:
store data indicative of one or more user interactions between a user and one or more computing devices;
based on the one or more user interactions, update one or more portions of user-specific conditioning data that comprises natural language text that describes attributes of the user, wherein the user-specific conditioning data is maintained in memory accessible to one or more applications to subsequently condition a generative model to generate output that is tailored to one or more of the attributes of the user;
store one or more mappings between the one or more updated portions of the user-specific conditioning data and the data indicative of the one or more user interactions in the one or more data sources;
detect an alteration of one or more of the user interactions has been altered;
in response to the detection, and using one or more of the mappings as a reverse lookup to one or more of the data sources, update one or more of the portions of the user-specific conditioning data to reflect the alteration of the one or more user interactions; and
cause the user-specific conditioning data to be assembled into a prompt that is applied as input across the generative model to generate the output that is tailored to one or more of the attributes of the user.

20. The system of claim 19, wherein the one or more user interactions comprise one or more of:
emails sent or received by the user using one or more of the computing devices;
a document accessed by the user using one or more of the computing devices;
a software application installed on one or more of the computing devices and used by the user;
a change to an installed software application on one or more of the computing devices and used by the user;
a change made to a software application settings or functionality on one or more of the computing devices and used by the user;
a change made to a computing device configuration on one or more of the computing devices and used by the user;
a change made to a security or privacy configuration of a resource controlled by the user;
one or more digital images captured or altered by the user;
one or more content purchases by the user;
rejection of generative model output provided to the user based on the user-specific conditioning data;
one or more social media posts of the user;
one or more location trajectories accumulated by one or more of the computing devices; or
one or more readings from one or more physiological sensors worn by the user.
